(19) United States
(12) Patent Application Publication
(10) Pub. No.: US 2022/0116672 A1
(43) Pub. Date: Apr. 14, 2022

(54) METHOD, DEVICE, AND STORAGE MEDIUM FOR INTERACTING INFORMATION

(71) Applicant: BEIJING XIAOMI MOBILE SOFTWARE CO., LTD., Beijing (CN)

(72) Inventors: Xutao DU, Beijing (CN); Ming LIU, Beijing (CN)

(21) Appl. No.: 17/323,806

(22) Filed: May 18, 2021

(30) Foreign Application Priority Data
Oct. 14, 2020 (CN) 202011097459.X

(51) Int. Cl. H04N 21/41; H04N 21/6334; H04W 8/00

(52) U.S. Cl. CPC H04N 21/4126; H04W 8/005; H04N 21/6334; H04N 21/4122

(57) ABSTRACT

A method for interacting information is provided. The method is for a mobile terminal. The method may include the following. A target device is searched for, in which the target device is a device that supports an establishment of a directional wireless communication connection. At least one searched target device is determined. Identification information of the at least one searched target device is displayed.

### CROSS-REFERENCE TO RELATED APPLICATION

This application is based upon and claims priority to Chinese Patent Application No. 202011097459.X filed on Oct. 14, 2020, the entire contents of which are incorporated herein by reference.

### TECHNICAL FIELD

The disclosure relates to the field of data processing technologies of mobile terminals, and more particularly, to a method for interacting information, an apparatus for interacting information, and a storage medium.

### BACKGROUND

When realizing interconnection and intercommunication between a mobile terminal and other device, a complicated interaction process and connection confirmation may be performed between the mobile terminal and the other device. Especially, when the same mobile terminal faces multiple devices, a selection operation may need to be performed first for the mobile terminal. When the multiple devices include devices of the same type from the same manufacturer, device names displayed by these devices are generally the same, which is another difficulty for the selection of the mobile terminal.

It is a technical problem that needs to be solved how to quickly and conveniently select the device to be connected for the mobile terminal.

### SUMMARY

According to a first aspect of embodiments of the disclosure, a method for interacting information is provided. The method is for a mobile terminal. The method may include the following. A target device is searched for, in which the target device is a device that supports an establishment of a directional wireless communication connection. At least one searched target device is determined. Identification information of the at least one searched target device is displayed.

According to a second aspect of embodiments of the disclosure, a device for interacting information is provided. The device includes a processor; and a memory for storing instructions executable by the processor. The processor is configured to execute the instructions in the memory to perform actions of the method as described.

According to a third aspect of embodiments of the disclosure, a non-transitory computer-readable storage medium is provided. The non-transitory computer-readable storage medium has stored therein instructions that, when executed by a processor, causes the processor to perform actions of the method as described.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart illustrating a method for interacting information, according to an exemplary embodiment.

FIG. 2 is a schematic diagram illustrating a search result interface, according to an exemplary embodiment.

FIG. 3 is a schematic diagram illustrating a search result interface, according to an exemplary embodiment.

FIG. 4 is a schematic diagram illustrating a search result interface, according to an exemplary embodiment.

FIG. 5 is a schematic diagram illustrating a search result interface, according to an exemplary embodiment.

FIG. 6 is a flow chart illustrating a method for interacting information, according to an exemplary embodiment.

FIG. 7 is a schematic diagram illustrating a search result interface, according to an exemplary embodiment.

FIG. 8 is a flow chart illustrating a method for interacting information, according to an exemplary embodiment.

FIG. 9 is a block diagram illustrating an apparatus for interacting information, according to an exemplary embodiment.

FIG. 10 is a block diagram illustrating an apparatus for interacting information, according to an exemplary embodiment.

FIG. 11 is a block diagram illustrating a device for interacting information, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

The embodiments of the disclosure provide a method for interacting information. This method is applicable to a mobile terminal. The mobile terminal may be a computer device that may be used on the move, such as a mobile phone, a notebook computer, a tablet computer, and the like.

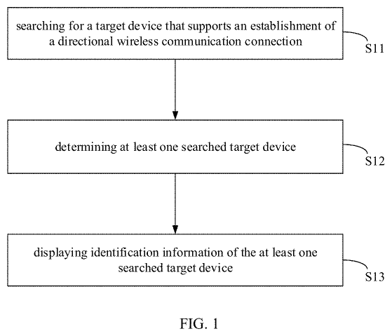

Referring to FIG. 1, FIG. 1 is a flow chart illustrating a method for interacting information, according to an exemplary embodiment. As illustrated in FIG. 1, the method may include the following.

At block S11, a target device that supports an establishment of a directional wireless communication connection is searched for.

At block S12, at least one searched target device is determined.

At block S13, identification information of the at least one searched target device is displayed.

The directional wireless communication connection refers to a wireless communication connection that may perform positioning and distance measurement. For example, the directional wireless communication connection refers to an ultra-wide band (UWB) connection.

When the mobile terminal is equipped with a UWB module, other devices equipped with UWB function modules may be discovered, or the mobile terminal may be discovered by other devices equipped with UWB function modules. After the discovery is completed, relative position information of other devices equipped with UWB function modules relative to the mobile terminal may be detected. The relative position information may include an angle between directional signals of the two and a distance between the two.

In some embodiments, the manner of searching for the target device at block S11 may include the following.

Manner 1: a broadcast scan signal is sent. The broadcast scan signal is configured to discover devices that support directional wireless communication connections. It is determined that the device matching the broadcast scan signal is the searched target device.

Or, manner 2: a broadcast scan signal is received. It is determined that the mobile terminal matches the broadcast scan signal, and the device of sending the broadcast scan signal is the searched target device.

In manner 1, the mobile terminal initiates a broadcast scan, and in manner 1, the other device (such as a TV equipped with a UWB function module) initiates a broadcast scan.

The broadcast scan signal is a broadcast signal. Other devices with the same type of directional wireless communication connection function may recognize this broadcast signal. The device that recognizes the broadcast signal may send a response signal. The response signal may carry identification information of the directional wireless communication connection function module of the device. After receiving the response signal, the mobile terminal may determine that the device of sending the response signal is a matched device.

For example, the mobile terminal has a UWB function module. The mobile terminal may send a UWB broadcast scan signal through the UWB function module. By receiving the response signal, at least one target device that sends the response signal is determined. The identifier of the UWB function module of each target device is learned, and the relative position of each matched target device and the mobile terminal is also known.

For the convenience of users, the mobile terminal may also be marked with an indicator of representing a direction of a UWB signal. For example, when the direction of the UWB signal is a direction that is perpendicular to an upper edge of the front of the mobile terminal and faces outward, the mobile terminal is marked with an upward arrow on the upper edge of the front of the device housing. Or, when a UWB instruction interface is opened, it is indicated on the interface that the direction of the UWB signal is a direction that is perpendicular to an upper edge of the front of the mobile terminal and faces outward.

In the embodiments, the device that supports the establishment of the directional wireless communication connection may be searched for. The searched device may be displayed, so that a user may learn about an available device that supports the establishment of the directional wireless communication connection, and employ characteristics of detecting positions and distances of the directional wireless communication connection to perform required operations, which improves the convenience of the operations and improves the user experience.

Embodiments of the disclosure provide a method for interacting information. The method may include actions illustrated in FIG. 1. Furthermore, the searching for the target device at block S11 may include: searching for the target device based on a set condition. The set condition may include: an angle between a directional signal of the target device and a directional signal of the mobile terminal being within a set angle range, and/or, a distance between the target device and the mobile terminal being within a set distance range.

In some embodiments, the set angle range is a range greater than or equal to a first angle and less than or equal to a second angle. The first angle is a difference between 180 degrees and a third angle. The second angle is a sum of 180 degrees and a fourth angle. The third angle and the fourth angle are both less than 90 degrees. The third angle and the fourth angle may be the same or different.

For example: the set angle range is (175 degrees, 185 degrees), (170 degrees, 190 degrees), [170 degrees, 190 degrees], (160 degrees, 200 degrees), [160 degrees, 200 degrees], (150 degrees, 210 degrees), (170 degrees, 200 degrees), etc.

The set distance range is related to a coverage capacity of a directional wireless communication signal. When a coverage range of the wireless communication signal is larger, a larger set distance range may be set. When a coverage range of the wireless communication signal is smaller, a smaller set distance range may be set.

For example: the set distance range is (3 meters, 10 meters), (2 meters, 15 meters), (2.5 meters, 12 meters), etc.

In the embodiments, by employing the function of detecting orientations and distances in the scanning process of the directional wireless communication connection, it is convenient and quick to determine the device whose angle and/or distance relative to the mobile terminal satisfy requirements, so that the user may easily and quickly determine the device needed to be connected, which may simplify the operation process of interconnection and intercommunication between devices and improve the user experience.

Embodiments of the disclosure provide a method for interacting information. The method may include actions illustrated in FIG. 1. Furthermore, the method may include the following.

At least one control is displayed, in which each control corresponds to one searched target device.

A touch signal for one control is received.

A target device corresponding to the control to which the touch signal belongs is determined.

A directional wireless communication connection with the determined target device is established.

A data processing function corresponding to the control is realized through the established directional wireless communication connection.

The data processing function corresponding to the control may be screen projecting, sending set data, etc.

In the embodiments, the control corresponding to the data processing function set may be displayed, so that after the user clicks the corresponding control for the target device to be used, the directional wireless communication connection with the target device may be established, and the corresponding data processing function may be executed automatically, which may simplify the user's operation flow.

The following two examples are used to explain in detail.

### EXAMPLE 1

The user may select a screen projecting function on a system setting interface of the mobile terminal and turn on a UWB function. The user may hold the mobile terminal to point to a TV with a UWB module. After the mobile terminal searches for the device that supports the establishment of the directional wireless communication connection, this TV is found. It is also known that the name of this TV is “XY TV in living room”.

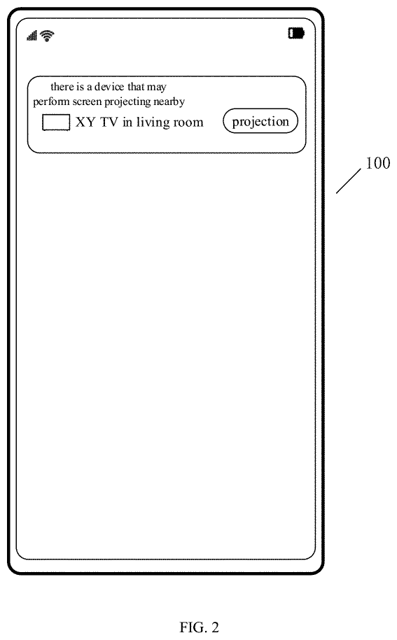

As illustrated in FIG. 2, a notification box is displayed on a current display interface of the mobile terminal 100. The notification box may display a prompt message of “there is a device that may perform screen projecting nearby”, the name “XY TV in living room” of the TV, and the control displayed with the word “projection” and corresponding to the name of the TV (which is also called as a projection control).

After the user clicks on this projection control, it means that it is confirmed to send projecting data to the TV. After the mobile terminal 100 receives this click signal, it may automatically establish a UWB wireless connection with the TV, and send the projecting data of the mobile terminal 100 to the TV. The TV may receive the projecting data through the UWB wireless connection, and display the projecting data. Therefore, the mobile terminal 100 and the TV may play the same projecting data synchronously.

### EXAMPLE 2

The user may select a screen projecting function on a system setting interface of the mobile terminal and turn on a UWB function. After the mobile terminal searches for the device that supports the establishment of the directional wireless communication connection, two TVs are found. It is also known that the name of the first TV is “XY TV in living room”, and the name of the second TV is “XY TV in bedroom”.

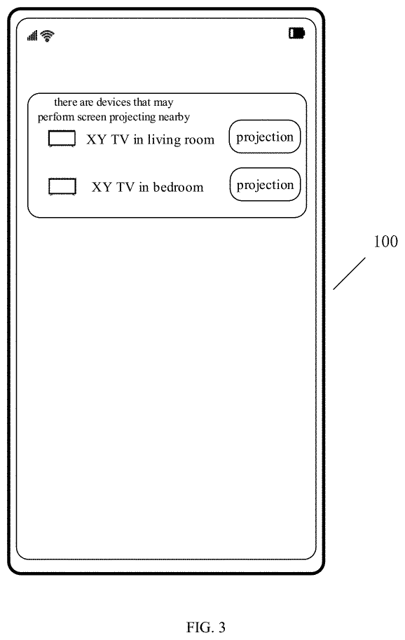

As illustrated in FIG. 3, a notification box is displayed on a current display interface of the mobile terminal 100. The notification box may display a prompt message of “there are devices that may perform screen projecting nearby”, the name of each TV, and the control displayed with the word “projection” and corresponding to the name of each TV (which is also called as a projection control). The name of each TV corresponds to one control.

After the user clicks on the projection control corresponding to “XY TV in living room”, it means that it is confirmed to send projecting data to this TV. After the mobile terminal 100 receives this click signal, it may automatically establish a UWB wireless connection with this TV, and send the projecting data of the mobile terminal 100 to this TV. This TV may receive the projecting data through the UWB wireless connection, and display the projecting data. Therefore, the mobile terminal 100 and this TV may play the same projecting data synchronously.

Embodiments of the disclosure provide a method for interacting information. The method may include actions illustrated in FIG. 1. Furthermore, the method may include the following.

Relative position information of the at least one searched target device and the mobile terminal is displayed.

The manner of displaying the relative position information of the at least one searched target device and the mobile terminal may include the following two manners.

Manner 1: information of each searched target device may be displayed in a form of list, and identification information of the target device and the relative position information of the target device and the mobile terminal may be displayed in a unit where each target device is located (this unit is a row or column).

Manner 2: at least one device area on a display interface may be determined, in which each device area corresponds to one searched target device; a distribution position of each device area on the display interface represents the relative position information of the corresponding target device and the mobile terminal.

In the embodiments, by displaying the relative position information, the user is provided with a visualized device distribution situation, so that the user may easily learn positions of surrounding devices that may receive directional wireless communication connections, to facilitate subsequent selection and employ.

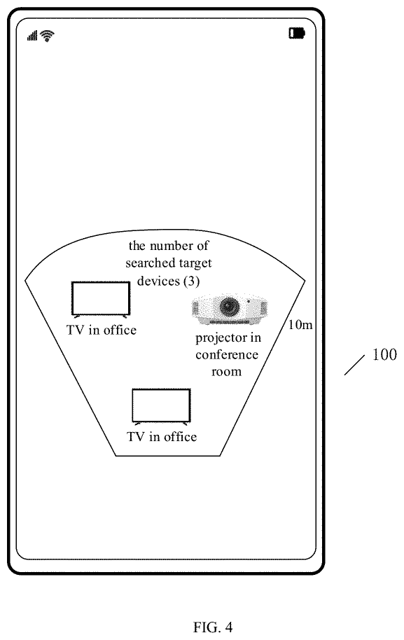

For example: as illustrated in FIG. 4, the number of searched target devices displayed in the search result interface is 3, including two TVs and one projector. The default names of the two TVs are both “TV in office” because the manufacturers of the two TVs are the same. The representative icon and name of each target device are displayed in the device area of the corresponding target device. The layout of the three devices displayed in the search result interface reflects the angle between the UWB signal of each device and the UWB signal of the mobile terminal 100 and the distance between each device and the mobile terminal 100. The search result interface also displays a fan-shaped area, and the fan-shaped area includes the device area corresponding to each target device. The position of the middle point of the bottom line segment of the fan-shaped area corresponds to the position of the mobile terminal 100. The distribution position of the device area in the fan-shaped area and corresponding to each target device in the fan-shaped area represents the relative position information of the corresponding target device and the mobile terminal 100. The “10 m (meters)” displayed on the right side of the fan-shaped area indicates the length of the side line segment of the fan-shaped area. The user may estimate the distance between each target device and the mobile terminal 100 based on the length of the side line segment. It may be seen from the search result interface that the distance between the lowest TV and the mobile terminal 100 is the closest, and the angle of corresponding UWB signals is closest to 180 degrees.

In some embodiments, the method may further include the following. At least one of the following information of the device may be displayed in the search result interface: the icon of the device, the name of the device, whether the UWB connection has been established with the mobile terminal, the distance to the mobile terminal, the angle between the transmitted directional signal and the transmitting direction of the directional signal transmitted by the mobile terminal, and indicating information for indicate that the angle between the transmitted directional signal and the transmitting direction of the directional signal transmitted by the mobile terminal is closest to 180 degrees (for example, this indicating information is “pointing at this device” “aligning with this device”). By displaying the above-mentioned information of the target device, the user may learn more device-related information, which is convenient for the user to perform subsequent operations on the target device.

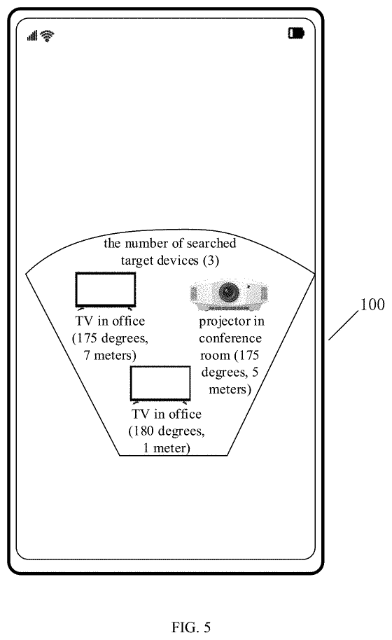

For example: in the search result interface illustrated in FIG. 5, compared to FIG. 4, the angle of corresponding UWB signals and the distance between each target device and the mobile terminal 100 are displayed in the device area of each target device, so that the user may check the accurate relative position of each target device and the mobile terminal 100. Because the specific distance between the target device and the mobile terminal 100 is illustrated in FIG. 5, there is no need to display the length of the side line segment of the fan-shaped area.

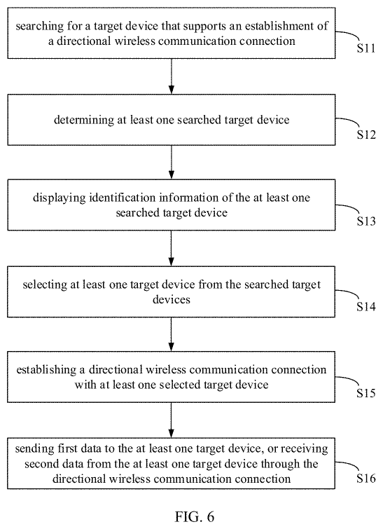

Embodiments of the disclosure provide a method for interacting information. The method may include actions illustrated in FIG. 1. Furthermore, the method may include the following as illustrated in FIG. 6.

At block S14, at least one target device is selected from the searched target devices.

At block S15, a directional wireless communication connection with at least one selected target device is established.

At block S16, first data is sent to the at least one target device, or second data is received from the at least one target device, through the directional wireless communication connection.

In some embodiments, selecting the at least one target device from the searched target devices at block S14 may include at least one of the following.

One, a touch signal is received, and a target device corresponding to a device area to which the touch signal belongs is selected.

Two, a target device corresponding to an angle closest to 180 degrees among angles between a directional signal transmitted by the mobile terminal and directional signals transmitted by the searched target devices, is selected.

Three, target devices corresponding to angles where differences with 180 degrees are less than a set angle among angles between a directional signal transmitted by the mobile terminal and directional signals transmitted by the searched target devices, is selected.

Four, a target device corresponding to a smallest distance among distances between the mobile terminal and the searched target devices, is selected.

Five, target devices corresponding to distances less than a set distance among distances between the mobile terminal and the searched target devices, is selected.

In the embodiments, by selecting the at least one target device from the searched target devices and setting selection conditions, the user may select the desired device. In order to select the desired device faster and more accurately, the user needs to move the mobile terminal close to the TV and points the transmitting direction of the UWB signal of the mobile terminal to the TV only, and the device to be connected may be easily selected.

The following two examples are used to illustrate.

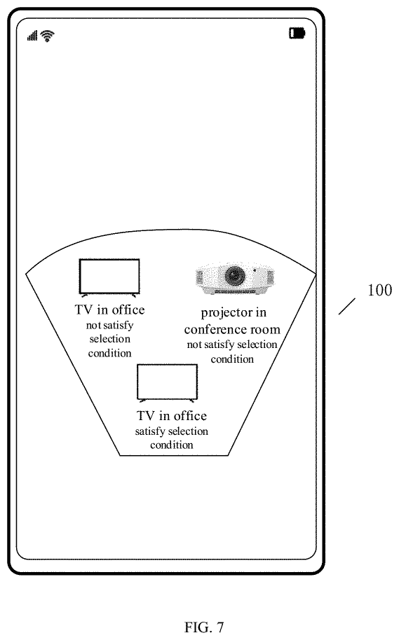

Example 1: when the selection condition is the above fourth condition, in the search result interface as illustrated in FIG. 7, it is displayed in the device area of each target device whether each target device satisfies the selection condition, making it easier for the user to distinguish the devices that satisfy the selection condition and the devices that do not satisfy the selection condition. Therefore, the subsequent actions may be carried out smoothly.

Example 2: the selection condition is that the difference between the angle between the transmitted directional signal and the directional signal of the mobile terminal and 180 degrees is less than 10 degrees, and the distance from the mobile terminal is less than 10 meters. The user holds the mobile terminal and aligns the transmitting direction of the UWB signal in the mobile terminal with a TV with a UWB function. After scanning multiple devices including this TV, the user may know that the angle between the transmitting direction of the UWB signal of the TV and the transmitting direction of the UWB signal of the mobile terminal is 185 degrees, and the distance between this TV and the mobile terminal is 3 meters. It is determined that the difference between the degrees of the above angle and 180 degrees is less than 10 degrees, and the above distance is less than 10 meters, so that the TV is determined as the target device.

In some embodiments, the selection may be performed at block S14 based on the touch operation of the user, which may include the following. A touch operation for the search result display interface is received. The target device corresponding to the touch operation is determined. The target device corresponding to the touch operation is set as the selected target device.

Alternatively, the action at block S14 is a process of automatic selection. After setting the selection condition, when multiple target devices are searched for, the device that satisfies the selection condition is automatically selected, and the connection may be automatically established after the device that satisfies the selection condition is selected, which save the operation process of the user.

In some embodiments, the method may further include the following between the action at block S15 and the action at block S16. A confirmation interactive interface is displayed. A first control for confirming sending the first data to the target device and/or a second control for confirming receiving the second data from the target device are displayed on the confirmation interactive interface. Touch information for the first control and/or the second control is received.

In the embodiments, after the user confirms, the first data is sent to the target device or the second data is received from the target device, so as to prevent the mobile terminal from making unnecessary connections in case of accidental touch.

In some embodiments, the first data at S17 is at least one of the following: screen projecting data, network access information, login account information, a multimedia file, and a trusted device logo, of the mobile terminal.

The second data at S17 is at least one of the following: a unique identifier, screen projecting data, network access information, login account information, and a multimedia file, of the target device.

The following is an example for description.

The user points the mobile terminal to the target device along the transmitting direction of the directional wireless signal, quickly searches for and selects the target device, and establishes the wireless connection with the target device.

Example 1: when the first data is the screen projecting data of the mobile terminal, the screen projecting data of the mobile terminal is sent to the target device through the established connection, so that the target device and the mobile terminal may display the screen display data of the mobile terminal synchronously to achieve the effect of rapid screen projecting.

Example 2: when the first data is the network access information of the mobile terminal, the network access information is sent to the target device through the established connection, so that the target device employs the network access information to quickly and automatically access the WIFI (Wireless Fidelity) network. Thus, the effect of the mobile terminal pulling the target device into the same WIFI network may be conveniently realized.

Example 3: when the first data is the multimedia file of the mobile terminal, the multimedia file is sent to the target device through the established connection, which facilitates and quickly completes the file transfer across devices.

Example 4, when the first data is the trusted device logo, the trusted device logo is sent to the target device through the established connection, and a new attribute may be added to the target device, so that the target device knows that it is trusted for this mobile terminal. The target device has a higher priority than other devices that are not trusted devices of the mobile terminal. In subsequent multiple connections, the target device may send the attribute of the trusted device for the mobile terminal, so that the mobile terminal may easily distinguish between trusted devices and untrusted devices.

Example 5: when the second data is the unique identifier of the target device, the unique identifier of the target device is received through the established connection, and the unique identifier of the device may be easily obtained, which may be used for subsequent other types of connections.

Example 6, when the second data is the screen projecting data of the target device, the screen projecting data of the target device is received through the established connection to achieve the effect of rapid screen projecting.

Example 7, when the second data is the network access information, the network access information is received through the established connection, so that the mobile terminal employs the network access information to quickly and automatically access the corresponding network.

Example 8, when the second data is the multimedia file, the multimedia file is received through the established connection, which facilitates and quickly completes the file transfer across devices.

The embodiments of the disclosure provide a method for interacting information, which is applicable to a device. The target device is a TV, a mobile phone, a tablet computer, etc.

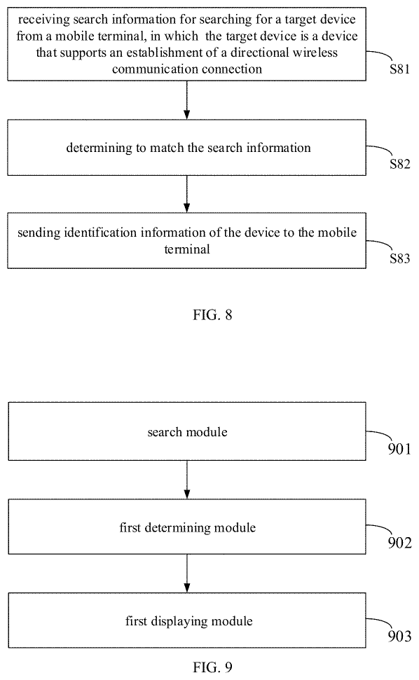

Referring to FIG. 8, FIG. 8 is a flow chart illustrating a method for interacting information, according to an exemplary embodiment. As illustrated in FIG. 8, the method may include the following.

At block S81, search information for searching for a target device is received from a mobile terminal, in which the target device is a device that supports an establishment of a directional wireless communication connection.

At block S82, it is determined to match the search information.

At block S83, identification information of the device is sent to the mobile terminal.

A detailed description is given below through several embodiments.

### Embodiment One

The mobile phone has the UWB function. The transmitting direction of the UWB signal of the mobile phone is by default a direction that is perpendicular to the upper edge of the mobile phone and faces outward.

There are 3 TVs with UWB functions in the conference room. The user wants to select one of them to perform the screen projecting.

The UWB function of the mobile phone is turned on. The user clicks on the projection control on the system setting interface of the mobile terminal, and the mobile terminal searches for devices that support the UWB functions. The mobile phone sends the UWB broadcast scan signal. After the scan is completed, a total of 3 TVs are searched, the search result interface is displayed, and the search result is displayed visually through the search result interface. As illustrate in FIG. 5, the icon of the TV, the name of the TV, the corresponding angle and distance are displayed in the device area of each TV.

The user clicks on the area corresponding to the TV at the bottom to confirm the selection of this TV.

The mobile terminal establishes the UWB wireless connection with this TV, and sends the projecting data of the mobile terminal to this TV, so that this TV may simultaneously play the screen content of the mobile terminal.

### Embodiment Two

The process of the first half of Embodiment two is the same as that of Embodiment one. The difference is that after the user clicks on the area corresponding to the TV at the bottom to confirm the selection of this TV, a confirmation interactive interface is displayed on the mobile phone, and the confirmation interactive interface is displayed with a control for indicating a confirmation to send projecting data to the target device. The word “projection” is displayed on this control. After the user clicks on this control, it confirms to send the projecting data to the TV. After the mobile terminal receives this click signal, it may establish the UWB wireless connection with the TV, and send the projecting data of the mobile terminal to the TV, so that the TV may play the screen display content of the mobile terminal synchronously. Or, after the TV establishes the UWB wireless connection with the target device, a confirmation interactive interface is displayed. After the user clicks on the word “projection”, the projecting data may be sent through the UWB wireless connection.

### Embodiment Three

The condition for selecting the target device may be set as follows: the angle between the transmitting direction of the UWB signal and the transmitting direction of the UWB signal of the mobile phone is greater than 170 degrees and less than 190 degrees.

The mobile phone has the UWB function. The transmitting direction of the UWB signal of the mobile phone is by default a direction that is perpendicular to the upper edge of the mobile phone and faces outward.

There are 3 TVs with UWB functions in the conference room. The user wants to select one of them to perform the screen projecting.

The UWB function of the mobile phone is turned on. The user clicks on the projection control on the system setting interface of the mobile terminal, and the mobile terminal searches for devices that support the UWB functions. The mobile phone sends the UWB broadcast scan signal. After the scan is completed, a total of 3 TVs are searched, the search result interface is displayed, and the search result is displayed visually through the search result interface. As illustrate in FIG. 7, the icon of the TV, the name of the TV, and whether the selection condition is satisfied are displayed in the device area of each TV.

The user moves the mobile phone to change the transmitting direction of the UWB signal. “whether the selection condition is satisfied” displayed on the scanning result interface changes accordingly.

After the information of “whether the selection condition is satisfied” of each device remains unchanged for more than 30 seconds, the device that satisfies the selection condition is automatically determined as the selected target device. As illustrate in FIG. 7, the TV at the bottom is automatically selected.

The mobile terminal establishes the UWB wireless connection with the selected TV, and sends the projecting data of the mobile terminal to this TV, so that this TV may simultaneously play the screen content of the mobile terminal.

### Embodiment Four

The condition for selecting the target device may be set as follows: the angle between the transmitting direction of the UWB signal and the transmitting direction of the UWB signal of the mobile phone is greater than 170 degrees and less than 190 degrees.

The mobile phone has the UWB function. The transmitting direction of the UWB signal of the mobile phone is by default a direction that is perpendicular to the upper edge of the mobile phone and faces outward.

The UWB function of the mobile phone is turned on. The user clicks on the control for synchronizing the network access information on the system setting interface of the mobile terminal and selects the corresponding network. The mobile phone sends the UWB broadcast scan signal. After the scan is completed, a total of 1 TV is searched. The search result interface is displayed, and the search result interface includes the TV icon and TV name of this TV. When the user clicks on the TV icon, the mobile terminal establishes the UWB wireless connection with this TV and sends the network access information to this TV, so that the TV automatically accesses the corresponding network through the network access information.

### Embodiment Five

The first TV enters the network connection page.

The mobile phone has been connected to a WIFI network, and saves the network access information of this WIFI network. The mobile phone has the UWB function. The transmitting direction of the UWB signal of the mobile phone is by default a direction that is perpendicular to the upper edge of the mobile phone and faces outward.

The UWB function of the mobile phone is turned on. The user clicks on the control for synchronizing the network access information on the system setting interface of the mobile terminal and selects the corresponding network. The mobile phone sends the UWB broadcast scan signal. After the scan is completed, the first TV is searched. The two automatically establish the UWB connection. The network access information is sent to the first TV through the UWB connection. The first TV uses the received network access information to automatically add the network access information on the network connection page, and automatically access the above-mentioned WIFI network.

### Embodiment Six

User A's mobile phone (mobile phone 1) has the UWB function, and this mobile phone has been connected to the company's WIFI network. User B's mobile phone (mobile phone 2) and User C's mobile phone (mobile phone 3) both have UWB functions, and User B and User C also both want to connect to this WIFI network.

The mobile phone of User B is placed closer to the mobile phone of User C. User A points the mobile phone to the direction of the mobile phone of User B and the mobile phone of User C.

The mobile phone of User A sends the UWB broadcast scan signal. After the scan is completed, the search result interface is displayed on the mobile phone, and a total of 3 mobile phones are scanned and displayed on the search result interface. User A's mobile phone automatically selects the target devices including mobile phone 2 and mobile phone 3. Mobile phone 1 automatically establishes UWB wireless connections with mobile phone 2 and mobile phone 3, and sends the network access information to the WIFI network to these two mobile phones. Mobile phone 2 and mobile phone 3 may employ the received network access information to automatically access the WIFI network. Therefore, mobile phone 1 may connect mobile phone 2 and mobile phone 3 to the same WIFI network simply and quickly.

The embodiments of the disclosure provide an apparatus for interacting information. The apparatus is applicable to a mobile terminal. The mobile terminal may be a computer device that may be used on the move, such as a mobile phone, a notebook computer, a tablet computer, and the like.

Referring to FIG. 9, FIG. 9 is a block diagram illustrating an apparatus for interacting information, according to an exemplary embodiment. As illustrated in FIG. 9, the apparatus may include a search module 901, a first determining module 902, and a first displaying module 903.

The search module 901 is configured to search for a target device that supports an establishment of a directional wireless communication connection.

The first determining module 902 is configured to determine at least one searched target device.

The first displaying module 903 is configured to display identification information of the at least one searched target device.

In some embodiments, the search module is further configured to search for the target device based on a set condition.

The set condition may include the following. An angle between a directional signal of the target device and a directional signal of the mobile terminal is within a set angle range, and/or, a distance between the target device and the mobile terminal is within a set distance range.

The embodiments of the disclosure provide an apparatus for interacting information. The apparatus may include the apparatus in FIG. 9, and the apparatus further includes a second displaying module, a first receiving module, a second determining module, an establishing module, and a processing module.

The second displaying module is configured to display at least one control, each control corresponding to one searched target device.

The first receiving module is configured to receive a touch signal for one control.

The second determining module is configured to determine a target device corresponding to the control to which the touch signal belongs.

The establishing module is configured to establish a directional wireless communication connection with the determined target device.

The processing module is configured to realize a data processing function corresponding to the control through the established directional wireless communication connection.

The embodiments of the disclosure provide an apparatus for interacting information. The apparatus may include the apparatus in FIG. 9, and the apparatus further includes a third displaying module.

The third displaying module is configured to display relative position information of the at least one searched target device and the mobile terminal.

In some embodiments, the third displaying module is further configured to display the relative position information of the at least one searched target device and the mobile terminal by: determining at least one device area on a display interface, each device area corresponding to one searched target device. A distribution position of each device area on the display interface, represents the relative position information of the corresponding target device and the mobile terminal.

The embodiments of the disclosure provide an apparatus for interacting information. The apparatus may include the apparatus in FIG. 9, and the apparatus further includes a selecting module, an establishing module, a sending module, and a second receiving module.

The selecting module is configured to select at least one target device from the searched target devices.

The establishing module is configured to establish a directional wireless communication connection with the at least one selected target device.

The sending module is configured to send first data to the at least one target device through the directional wireless communication connection.

The second receiving module is configured to receive second data from the at least one target device through the directional wireless communication connection.

In some embodiments, the selecting module is further configured to select the at least one target device from the searched target devices by at least one of: receiving a touch signal, and selecting a target device corresponding to a device area to which the touch signal belongs; selecting a target device corresponding to an angle closest to 180 degrees among angles between a directional signal transmitted by the mobile terminal and directional signals transmitted by the searched target devices; selecting target devices corresponding to angles where differences with 180 degrees are less than a set angle among angles between a directional signal transmitted by the mobile terminal and directional signals transmitted by the searched target devices; selecting a target device corresponding to a smallest distance among distances between the mobile terminal and the searched target devices; and selecting target devices corresponding to distances less than a set distance among distances between the mobile terminal and the searched target devices.

The embodiments of the disclosure provide an apparatus for interacting information. The apparatus may include the apparatus in FIG. 9. In some embodiments, the first data is at least one of: screen projecting data, network access information, login account information, a multimedia file, and a trusted device logo, of the mobile terminal. The second data is at least one of: a unique identifier, screen projecting data, network access information, login account information, and a multimedia file, of the target device.

The embodiments of the disclosure provide an apparatus for interacting information. The apparatus is applicable to a device. The device is a TV, a mobile phone, a notebook computer, a tablet computer, etc.

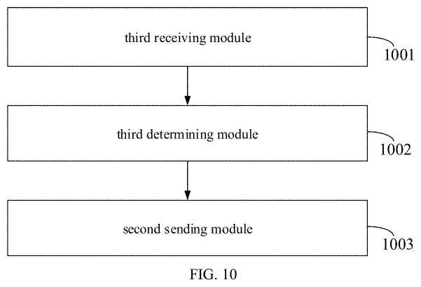

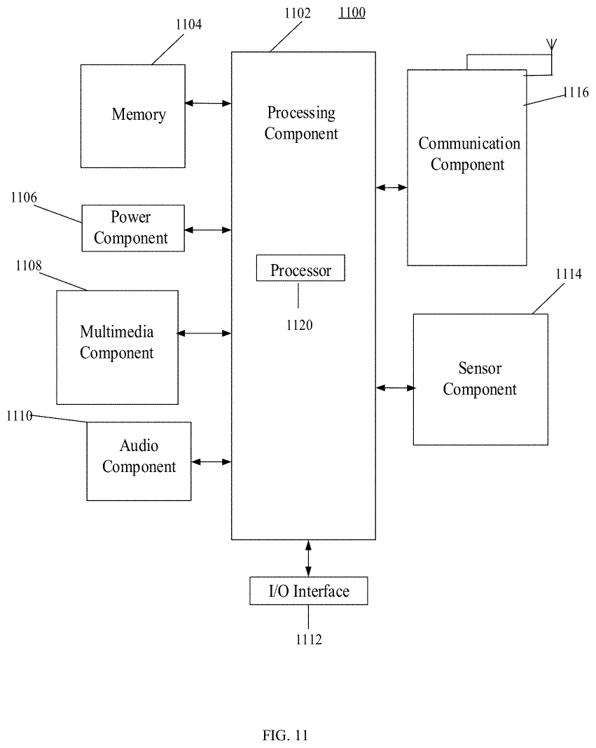

Referring to FIG. 10, FIG. 10 is a block diagram illustrating an apparatus for interacting information, according to an exemplary embodiment. As illustrated in FIG. 10, the apparatus may include a third receiving module 1001, a third determining module 1002, and a second sending module 1003.

The third receiving module 1001 is configured to receive search information for searching for a target device from a mobile terminal, in which the target device is a device that supports an establishment of a directional wireless communication connection.

The third determining module 1002 is configured to determine to match the search information.

The second sending module 1003 is configured to send identification information of the device to the mobile terminal.

The embodiments of the disclosure provide a device for interacting information. The device includes a processor; and a memory for storing instructions executable by the processor. The processor is configured to execute the instructions in the memory to perform actions of the method as described.

The embodiments of the disclosure provide a non-transitory computer-readable storage medium. The non-transitory computer-readable storage medium has stored therein instructions that, when executed by a processor, causes the processor to perform actions of the method as described.

FIG. 11 is a block diagram illustrating a device 1100 for interacting information, according to an exemplary embodiment.

For example, the device 1100 may be a mobile phone, a computer, a digital broadcast terminal, a messaging device, a gaming console, a tablet, a medical device, exercise equipment, a personal digital assistant, and the like.

Referring to FIG. 11, the device 1100 may include one or more of the following components: a processing component 1102, a memory 1104, a power component 1106, a multimedia component 1108, an audio component 1110, an input/output (I/O) interface 1112, a sensor component 1114, and a communication component 1116.

The processing component 1102 typically controls overall operations of the device 1100, such as the operations associated with display, telephone calls, data communications, camera operations, and recording operations. The processing component 1102 may include one or more processors 1120 to execute instructions to perform all or part of the steps in the above described methods. Moreover, the processing component 1102 may include one or more modules which facilitate the interaction between the processing component 1102 and other components. For instance, the processing component 1102 may include a multimedia module to facilitate the interaction between the multimedia component 1108 and the processing component 1102.

The memory 1104 is configured to store various types of data to support the operation of the device 1100. Examples of such data include instructions for any applications or methods operated on the device 1100, contact data, phonebook data, messages, pictures, video, etc. The memory 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 provides power to various components of the device 1100. The power component 1106 may include a power management system, one or more power sources, and any other components associated with the generation, management, and distribution of power in the device 1100.

The multimedia component 1108 includes a screen providing an output interface between the device 1100 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1108 includes a front camera and/or a rear camera. The front camera and the rear camera may receive an external multimedia datum while the device 1100 is in an operation mode, such as a photographing mode or a video mode. Each of the front camera and the rear camera may be a fixed optical lens system or have focus and optical zoom capability.

The audio component 1110 is configured to output and/or input audio signals. For example, the audio component 1110 includes a microphone (“MIC”) configured to receive an external audio signal when the device 1100 is in an operation mode, such as a call mode, a recording mode, and a voice recognition mode. The received audio signal may be further stored in the memory 1104 or transmitted via the communication component 1116. In some embodiments, the audio component 1110 further includes a speaker to output audio signals.

The I/O interface 1112 provides an interface between the processing component 1102 and peripheral interface modules, such as a keyboard, a click wheel, buttons, and the like. The buttons may include, but are not limited to, a home button, a volume button, a starting button, and a locking button.

The sensor component 1114 includes one or more sensors to provide status assessments of various aspects of the device 1100. For instance, the sensor component 1114 may detect an open/closed status of the device 1100, relative positioning of components, e.g., the display and the keypad, of the device 1100, a change in position of the device 1100 or a component of the device 1100, a presence or absence of user contact with the device 1100, an orientation or an acceleration/deceleration of the device 1100, and a change in temperature of the device 1100. The sensor component 1114 may include a proximity sensor configured to detect the presence of nearby objects without any physical contact. The sensor component 1114 may also include a light sensor, such as a CMOS or CCD image sensor, for use in imaging applications. In some embodiments, the sensor component 1114 may also include an accelerometer sensor, a gyroscope sensor, a magnetic sensor, a pressure sensor, or a temperature sensor.

The communication component 1116 is configured to facilitate communication, wired or wirelessly, between the device 1100 and other devices. The device 1100 can access a wireless network based on a communication standard, such as WiFi, 2G, or 3G, or a combination thereof. In one exemplary embodiment, the communication component 1116 receives a broadcast signal or broadcast associated information from an external broadcast management system via a broadcast channel. In one exemplary embodiment, the communication component 1116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 1104, executable by the processor 1120 in the device 1100, for performing the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the invention disclosed here. This application is intended to cover any variations, uses, or adaptations of the invention following the general principles thereof and including such departures from the disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for interacting information, for a mobile terminal, comprising:
searching for a target device that supports an establishment of a directional wireless communication connection;
determining at least one searched target device; and
displaying identification information of the at least one searched target device.

2. The method as claimed in claim 1, wherein,
the searching for the target device comprises: searching for the target device based on a set condition; and
the set condition comprises: an angle between a directional signal of the target device and a directional signal of the mobile terminal being within a set angle range, and/or, a distance between the target device and the mobile terminal being within a set distance range.

3. The method as claimed in claim 1, further comprising:
displaying at least one control, each control corresponding to one searched target device;
receiving a touch signal for one control;
determining a target device corresponding to the control to which the touch signal belongs;
establishing a directional wireless communication connection with the determined target device; and
realizing a data processing function corresponding to the control through the established directional wireless communication connection.

4. The method as claimed in claim 1, further comprising:
displaying relative position information of the at least one searched target device and the mobile terminal.

5. The method as claimed in claim 4, wherein the displaying the relative position information of the at least one searched target device and the mobile terminal comprises:
determining at least one device area on a display interface, each device area corresponding to one searched target device;
in which a distribution position of each device area on the display interface represents the relative position information of the corresponding target device and the mobile terminal.

6. The method as claimed in claim 1, further comprising:
selecting at least one target device from the searched target devices;
establishing a directional wireless communication connection with the at least one selected target device; and
sending first data to the at least one target device, or receiving second data from the at least one target device through the directional wireless communication connection.

7. The method as claimed in claim 6, wherein the selecting the at least one target device from the searched target devices comprises at least one of:
receiving a touch signal, and selecting a target device corresponding to a device area to which the touch signal belongs;
selecting a target device corresponding to an angle closest to 180 degrees among angles between a directional signal transmitted by the mobile terminal and directional signals transmitted by the searched target devices;
selecting target devices corresponding to angles where differences with 180 degrees are less than a set angle among angles between a directional signal transmitted by the mobile terminal and directional signals transmitted by the searched target devices;
selecting a target device corresponding to a smallest distance among distances between the mobile terminal and the searched target devices; and
selecting target devices corresponding to distances less than a set distance among distances between the mobile terminal and the searched target devices.

8. The method as claimed in claim 6, wherein,
the first data is at least one of:
screen projecting data, network access information, login account information, a multimedia file, and a trusted device logo, of the mobile terminal;
the second data is at least one of:
a unique identifier, screen projecting data, network access information, login account information, and a multimedia file, of the target device.

9. A mobile terminal for interacting information, comprising:
a processor; and
a memory for storing instructions executable by the processor;
wherein the processor is configured to execute the instructions in the memory to:
search for a target device that supports an establishment of a directional wireless communication connection;
determine at least one searched target device; and
display identification information of the at least one searched target device.

10. The mobile terminal as claimed in claim 9, wherein the processor is configured to execute the instructions in the memory to search for the target device based on a set condition; and
the set condition comprises: an angle between a directional signal of the target device and a directional signal of the mobile terminal being within a set angle range, and/or, a distance between the target device and the mobile terminal being within a set distance range.

11. The mobile terminal as claimed in claim 9, wherein the processor is configured to execute the instructions in the memory to:
display at least one control, each control corresponding to one searched target device;
receive a touch signal for one control;
determine a target device corresponding to the control to which the touch signal belongs;
establish a directional wireless communication connection with the determined target device; and
realize a data processing function corresponding to the control through the established directional wireless communication connection.

12. The mobile terminal as claimed in claim 9, wherein the processor is configured to execute the instructions in the memory to:
display relative position information of the at least one searched target device and the mobile terminal.

13. The mobile terminal as claimed in claim 12, wherein the processor is configured to execute the instructions in the memory to display the relative position information of the at least one searched target device and the mobile terminal by:
determining at least one device area on a display interface, each device area corresponding to one searched target device;
in which, a distribution position of each device area on the display interface represents the relative position information of the corresponding target device and the mobile terminal.

14. The mobile terminal as claimed in claim 9, wherein the processor is configured to execute the instructions in the memory to:
select at least one target device from the searched target devices;
establish a directional wireless communication connection with the at least one selected target device; and
send first data to the at least one target device, or receiving second data from the at least one target device through the directional wireless communication connection.

15. The mobile terminal as claimed in claim 14, wherein the processor is configured to execute the instructions in the memory to select the at least one target device from the searched target devices by at least one of:
receiving a touch signal, and selecting a target device corresponding to a device area to which the touch signal belongs;
receiving a touch signal, and selecting a target device corresponding to a device area to which the touch signal belongs;
selecting a target device corresponding to an angle closest to 180 degrees among angles between a directional signal transmitted by the mobile terminal and directional signals transmitted by the searched target devices;
selecting target devices corresponding to angles where differences with 180 degrees are less than a set angle among angles between a directional signal transmitted by the mobile terminal and directional signals transmitted by the searched target devices;
selecting a target device corresponding to a smallest distance among distances between the mobile terminal and the searched target devices; and
selecting target devices corresponding to distances less than a set distance among distances between the mobile terminal and the searched target devices.

16. Anon-transitory computer-readable storage medium having stored therein instructions that, when executed by a processor, causes the processor to perform a method for interacting information, the method being for a mobile terminal and comprising:
searching for a target device that supports an establishment of a directional wireless communication connection;
determining at least one searched target device; and
displaying identification information of the at least one searched target device.

17. The non-transitory computer-readable storage medium as claimed in claim 16, wherein,
searching for the target device comprises: searching for the target device based on a set condition; and
the set condition comprises: an angle between a directional signal of the target device and a directional signal of the mobile terminal being within a set angle range, and/or, a distance between the target device and the mobile terminal being within a set distance range.

18. The non-transitory computer-readable storage medium as claimed in claim 16, wherein the method further comprises:
displaying at least one control, each control corresponding to one searched target device;
receiving a touch signal for one control;
determining a target device corresponding to the control to which the touch signal belongs;
establishing a directional wireless communication connection with the determined target device; and
realizing a data processing function corresponding to the control through the established directional wireless communication connection.

19. The non-transitory computer-readable storage medium as claimed in claim 16, wherein the method further comprises:
displaying relative position information of the at least one searched target device and the mobile terminal.

20. The non-transitory computer-readable storage medium as claimed in claim 16, wherein the method further comprises:
selecting at least one target device from the searched target devices;
establishing a directional wireless communication connection with the at least one selected target device; and
sending first data to the at least one target device, or receiving second data from the at least one target device through the directional wireless communication connection.
